(19) United States
(12) Patent Application Publication
(10) Pub. No.: US 2025/0237331 A1
(43) Pub. Date: Jul. 24, 2025

(54) COMBINED PIPE FITTING AND AIR CONDITIONING SYSTEM PIPELINE

(71) Applicant: HANSHAN RUIKE METAL CO., LTD., Hangzhou, Zhejiang (CN)

(72) Inventors: Zhuangwei SI, Hangzhou, Zhejiang (CN); Dubo ZHANG, Hangzhou, Zhejiang (CN)

(21) Appl. No.: 18/689,370

(22) PCT Filed: Nov. 30, 2022
(86) PCT No.: PCT/CN2022/135397

§ 371 Date: Mar. 5, 2024

(30) Foreign Application Priority Data
Jul. 26, 2022 (CN) 202210883383.6

(51) Int. Cl. F16L 13/02; F16L 9/02

(52) U.S. Cl. CPC F16L 13/02; F16L 9/02

(57) ABSTRACT

A combined pipe fitting and an air conditioning system pipeline. The combined pipe fitting includes a first, a second, and a third pipe fitting. Both the first and the second pipe fittings are stainless steel pipes, and a first end of the second pipe fitting is connected to the first pipe fitting. The third pipe fitting is a copper pipe and includes a first connecting section, an effective section, and a second connecting section. The first connecting section is sleeved with a second end of the second pipe fitting. A length of the effective section L is an axial extension distance on the third pipe fitting from an end face of the second end of the second pipe fitting to a direction away from the first pipe fitting. A fatigue life N of the combined pipe fitting is inversely proportional to \sqrt{L}, and 1 mm≤L≤35 mm.

### BACKGROUND OF THE INVENTION

### Field of the Invention

The present invention relates to refrigeration accessories, in particular to a combined pipe fitting and an air conditioning system pipeline.

### Description of the Related Art

A liquid collecting pipe or gas collecting pipe is a common pipe fitting in an air conditioning pipeline, which consists of a main pipe and a plurality of distribution branch pipes welded to the wall of the main pipe. In the existing liquid collecting pipe or gas collecting pipe, the plurality of distribution branch pipes are made of a copper material, and after the main pipe and the plurality of distribution branch pipes are welded in one piece by furnace brazing, the grain size of the copper material becomes larger, which seriously affects the endurance limit of the pipe fitting under alternating stress.

In order to make the copper distribution branch pipes subjected to furnace brazing satisfy the requirements of fatigue strength, it is necessary to select an appropriate pipe wall thickness and outer diameter on the basis of a product model given by an air conditioning manufacturer. However, in the existing design, the selection of the pipe wall thickness and the outer diameter is fuzzy, and designers may only give a variety of combinations through experience for comparative testing, which not only results in high product development cost, long development cycle and low efficiency, but also is not conducive to use in practical model selection. Some people try to use the Goodman diagram to predict the fatigue life of pipe fittings with the wall thickness and outer diameter adjusted, but the application of the diagram has high requirements for professionals and the Goodman diagram needs to be drawn after pre-testing a large amount of data, so in China, this method is basically not effectively and widely popularized and used in the industrialization process, especially in this industry.

### BRIEF SUMMARY OF THE INVENTION

In order to overcome at least one defect in the prior art, the present invention provides a combined pipe fitting and an air conditioning system pipeline.

In order to achieve the above purpose, the present invention provides a combined pipe fitting. The combined pipe fitting includes a first pipe fitting, a second pipe fitting, and a third pipe fitting; both the first pipe fitting and the second pipe fitting are stainless steel pipes, and a first end of the second pipe fitting is connected to the first pipe fitting; the third pipe fitting is a copper pipe and includes a first connecting section, an effective section, and a second connecting section; the first connecting section is sleeved with a second end of the second pipe fitting; a length of the effective section is L, L is an axial extension distance on the third pipe fitting from an end face of the second end of the second pipe fitting to a direction away from the first pipe fitting, a fatigue life N of the combined pipe fitting is inversely proportional to \sqrt{L}, and 1 mm≤L≤35 mm; and the second connecting section is connected to an external pipe fitting.

According to an embodiment of the present invention, the length L and the fatigue life N of the combined pipe fitting satisfy the following formula:

$$N = \frac{k * t * ( {D}^{4} - {d}^{4} )}{\sqrt{LD} * {D}^{2}}$$

where D denotes a maximum outer diameter within the length L of the effective section, d denotes an inner diameter corresponding to D within the length L of the effective section, t denotes a minimum wall thickness within the length L of the effective section, and k denotes a fatigue life coefficient of the combined pipe fitting and decreases monotonically with D as a power function.

According to an embodiment of the present invention, the fatigue life coefficient k of the combined pipe fitting has the following power function fitting relationship with D:

$$k = 9 E + 06 {D}^{α} ,$$

where α is a negative value, and −2≤α≤−1.

According to an embodiment of the present invention, when a pressure in the combined pipe fitting fluctuates, a fluctuation differential pressure ΔP is less than or equal to 4 MPa and a fluctuation frequency is 0.2 Hz≤f≤0.3 Hz; and the fatigue life coefficient k of the combined pipe fitting and D satisfy the following power function fitting relationship:

$$k = 9 E + 06 {D}^{α} , where α = - 1.5 \pm 0.3 .$$

According to an embodiment of the present invention, the effective section is a straight pipe section in which both inner and outer diameters remain substantially unchanged and a central axis is approximately straight.

According to an embodiment of the present invention, the first connecting section of the third pipe fitting is necked to be sleeved with the second end of the second pipe fitting, and a wall thickness of the first connecting section is greater than or equal to a wall thickness of the effective section.

According to an embodiment of the present invention, the second connecting section of the third pipe fitting is sleeved with the external pipe fitting or connected to the external pipe fitting in a sleeving manner, and a sleeving length H satisfies H=βD, where 0.5≤β≤1.5, D denotes a maximum outer diameter within the length L of the effective section, and the sleeving length H refers to a distance from a joint position of the second connecting section and the external pipe fitting to an end face of the second connecting section.

According to an embodiment of the present invention, the second connecting section of the third pipe fitting is flared to be connected to the external pipe fitting in a sleeving manner, and a wall thickness of the second connecting section is less than or equal to a wall thickness of the effective section.

According to an embodiment of the present invention, a maximum outer diameter of the effective section is 4.2 mm≤D≤35 mm; and a wall thickness of the effective section is 0.3 mm≤t≤1.65 mm.

According to an embodiment of the present invention, the first pipe fitting, the plurality of second pipe fittings and the plurality of third pipe fittings are welded in one piece by furnace brazing.

According to an embodiment of the present invention, the first end of the second pipe fitting is connected to an end of the first pipe fitting; alternatively, a connecting hole is provided in a side wall of the first pipe fitting, and the first end of the second pipe fitting is connected to the connecting hole in the first pipe fitting.

According to an embodiment of the present invention, the combined pipe fitting includes a plurality of second pipe fittings and a plurality of third pipe fittings, a plurality of connecting holes are provided in a pipe wall of the first pipe fitting, the first ends of the second pipe fittings are connected to the corresponding connecting holes, and the second ends of the second pipe fittings are connected to the corresponding third pipe fittings.

In another aspect of the present invention, an air conditioning system pipeline is further provided. The air conditioning system pipeline includes the combined pipe fitting described above and a plurality of external pipe fittings. The plurality of external pipe fittings are correspondingly connected to second connecting sections of a plurality third pipe fittings respectively.

In summary, the combined pipe fitting according to this embodiment satisfies the requirements for the fatigue life N by accurate design of the length L of the effective section of the third pipe fitting; and in application, the appropriate length L of the effective section is determined on the basis of the given outer diameter D and wall thickness t of the effective section to clarify the product model selection before testing, thereby greatly increasing the development speed and reducing the market risk. Further, the fatigue life N of the combined pipe fitting may also be predicted on the basis of the fatigue life model established by fitting, and the economically optimal outer diameter of the third pipe fitting is selected under the premise of ensuring that the fatigue life N satisfies the requirements, so as to achieve accurate cost control.

In order to make the above and other objectives, features and advantages of the present invention more clearly understood, preferred embodiments are given and described in detail below in conjunction with the accompanying drawings.

### BRIEF DESCRIPTION OF THE DRAWINGS

FIG. 1 is a schematic diagram of a combined pipe fitting according to Embodiment 1 of the present invention.

FIG. 2 and FIG. 3 are schematic structural diagrams of a combined pipe fitting according to another embodiment of the present invention.

FIG. 4 is a schematic assembly diagram of a second pipe fitting, a third pipe fitting, and an external pipe fitting in FIG. 1.

FIG. 5 is a schematic structural diagram of a combined pipe fitting according to Embodiment 2 of the present invention.

FIG. 5A is a side view of FIG. 5.

FIG. 5B is a schematic structural diagram of another combined pipe fitting similar to that in FIG. 5.

FIG. 6 and FIG. 6A are schematic structural diagrams of a combined pipe fitting according to another embodiment of the present invention.

FIG. 7 and FIG. 7A are schematic structural diagrams of a combined pipe fitting according to another embodiment of the present invention.

FIG. 8 and FIG. 8A are schematic structural diagrams of a combined pipe fitting according to another embodiment of the present invention.

### DETAILED DESCRIPTION OF THE INVENTION

In order to solve the problem that the fatigue life of copper pipe fittings is shortened due to the increase of grain size after furnace brazing, a method of increasing the wall thickness of the pipe fittings is mainly used to prolong the fatigue life. However, in an air conditioning system, the cross-sectional area of refrigerant flow is generally not changed during parameter adjustment of the pipe fittings (that is, the inner diameter of the pipe fittings is generally not adjusted), so the increase of wall thickness may inevitably lead to the increase of outer diameter of the pipe fittings. On the one hand, the increase of outer diameter of pipe fittings may weaken the influence of the increase of wall thickness on the fatigue life. On the other hand, the increase of outer diameter of the pipe fittings may also affect the connection thereof to external pipes which are generally specified by an air conditioning manufacturer. Therefore, the wall thickness and the outer diameter may be mutually restricted. Therefore, it is difficult for designers to determine the appropriate wall thickness parameters between the two to satisfy the requirements for the fatigue life of pipe fittings. In addition, the increase of wall thickness of the pipe fittings may also bring about a significant increase in cost.

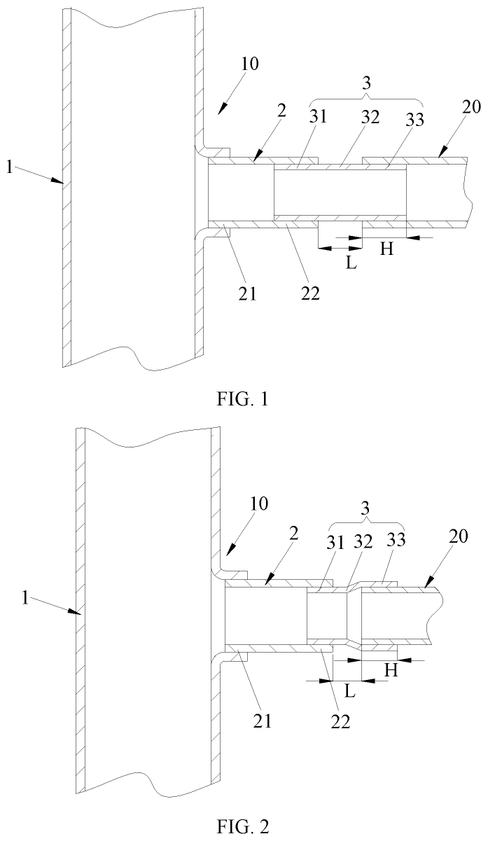

In view of this, as shown in FIG. 1, this embodiment provides a combined pipe fitting. The combined pipe fitting includes a first pipe fitting 1, a second pipe fitting 2, and a third pipe fitting 3. Both the first pipe fitting 1 and the second pipe fitting 2 are stainless steel pipes, and a first end 21 of the second pipe fitting 2 is connected to the first pipe fitting 1. The third pipe fitting 3 is a copper pipe and includes a first connecting section 31, an effective section 32, and a second connecting section 33. The first connecting section 31 is sleeved with a second end 22 of the second pipe fitting. The length of the effective section 32 is L, and L is an axial extension distance on the third pipe fitting 3 from an end face of the second end 22 of the second pipe fitting to a direction away from the first pipe fitting 1.

In order to solve the problem that the fatigue life of pipe fittings is shortened due to the large grain size of a copper pipe after furnace brazing, on the basis of the combined pipe fitting according to this embodiment in FIG. 1, the inventor has done a large number of fatigue strength tests. The conditions of the fatigue strength tests are derived from standard GB 4706.32-2012/IEC 60335-2-40:2005. Fatigue life refers to the number of stress cycles experienced by the material before a fatigue failure; and the number of cycles of 2.5*10⁵ specified by standard GB 4706.32-2012/IEC 60335-2-40:2005. In FIG. 1, the third pipe fitting 3 is a straight pipe in which both inner and outer diameters remain substantially unchanged and a central axis is approximately straight, the first connecting section 31 is sleeved with the second end 22 of the second pipe fitting 2, and the second connecting section 33 is sleeved with an external pipe fitting 20. However, since both the first connecting section 31 and the second connecting section 33 are sleeving connecting sections, the first connecting section and the second connecting section have high strength after being sleeved with the second pipe fitting 2 and the external pipe fitting 20. Therefore, neither the structure (e.g., flared or necked) nor the connecting manner (e.g., sleeved or sleeving) of the first connecting section 31 and the second connecting section 33 affects the fatigue tests in this embodiment.

The specific test conditions are as follows: a pump pipe injects liquid into a test product, and the following process is carried out: apply a liquid at a frequency of not less than 15 times/min, so the pressure increases from a low pressure P0=0.5±0.2 MPa to a high pressure P1=4.15 MPa; and repeatedly conduct pressurization or pressure relief 2.5*10⁵ times without leakage. At the end of the test, the product is kept in water at 6.35 MPa for 1 min, and it is observed that no leakage occurs in each portion.

Selection of test products: five test groups are selected according to the outer diameter D of the third pipe fitting 3, each test group includes three sub-test groups with different wall thicknesses t, and in each sub-test group, ten test products are formed according to the length L of the effective section of the third pipe fitting 3.

A total of 150 test products are provided, and the actual fatigue life of each test product is obtained after the above fatigue test. The specific test data is as shown in Table 1.

In the first test group, the outer diameter D is 7 mm; in the sub-test groups included therein, the wall thicknesses t are 0.5 mm, 0.6 mm, and 0.65 mm; and in each sub-test group, the lengths L of the effective section of the third pipe fitting 3 are 1 mm, 2 mm, 5 mm, 10 mm, 15 mm, 20 mm, 25 mm, 30 mm, 35 mm, and 40 mm.

In the second test group, the outer diameter D is 9.52 mm; in the sub-test groups included therein, the wall thicknesses t are 0.5 mm, 0.6 mm, and 0.7 mm; and in each sub-test group, the lengths L of the effective section of the third pipe fitting 3 are 1 mm, 2 mm, 5 mm, 10 mm, 15 mm, 20 mm, 25 mm, 30 mm, 35 mm, and 40 mm.

In the third test group, the outer diameter D is 12.7 mm; in the sub-test groups included therein, the wall thicknesses t are 0.6 mm, 0.65 mm, and 0.85 mm; and in each sub-test group, the lengths L of the effective section of the third pipe fitting 3 are 1 mm, 2 mm, 5 mm, 10 mm, 15 mm, 20 mm, 25 mm, 30 mm, 35 mm, and 40 mm.

In the fourth test group, the outer diameter D is 28.6 mm; in the sub-test groups included therein, the wall thicknesses t are 1.1 mm, 1.15 mm, and 1.2 mm; and in each sub-test group, the lengths L of the effective section of the third pipe fitting 3 are 1 mm, 2 mm, 5 mm, 10 mm, 15 mm, 20 mm, 25 mm, 30 mm, 35 mm, and 40 mm.

In the fifth test group, the outer diameter D is 35 mm; in the sub-test groups included therein, the wall thicknesses t are 1.15 mm, 1.35 mm, and 1.65 mm; and in each sub-test group, the lengths L of the effective section of the third pipe fitting 3 are 1 mm, 2 mm, 5 mm, 10 mm, 15 mm, 20 mm, 25 mm, 30 mm, 35 mm, and 36 mm.

After analyzing the data of the five test groups described above, it was found that in addition to the wall thickness t and the outer diameter D of the third pipe fitting 3, the fatigue life N of the test products was related to the length L of the effective section of the third pipe fitting after welding.

In order to find the specific influence of the length L of the effective section on the fatigue life of the test products, the data in Table 1 was analyzed.

First, the wall thickness t and the outer diameter D of the third pipe fitting 3 were fixed to study the influence of the length L of the effective section on the fatigue life N. Through simulation analysis, it was obtained that in the range of 1 mm≤L≤35 mm, the fatigue life N of the test products was inversely proportional to \sqrt{L}. According to this inverse proportional relationship, when the wall thickness t and the outer diameter D of the third pipe fitting 3 are determined, the fatigue life N of the pipe fitting may be prolonged by decreasing the length L of the effective section. Compared to the existing adjustments based on the pair of mutually restricted factors, namely the wall thickness t and the outer diameter D, this embodiment provides a combined pipe fitting that may satisfy the requirements for the fatigue life by adjusting the length L of the effective section of the third pipe fitting 3. Specifically, in practical application, the designer may initially select the wall thickness t and the outer diameter D of the pipe fitting that substantially satisfy the requirements, and then adjust the length L of the effective section to accurately satisfy the requirements for the fatigue life, which greatly reduces the difficulty of product model selection and significantly shortens the product development cycle.

However, with the gradual increase of price of copper materials in recent years, the influence of the wall thickness t of pipe fittings on the cost is particularly important. Therefore, during model selection design of the pipe fitting, it is hoped that under the premise of ensuring that the fatigue life N of the test product satisfies the standard requirements, the wall thickness t of the pipe fittings may be reduced as much as possible to control the cost. In this embodiment, the inverse proportional relationship between the fatigue life N of the test products and \sqrt{L} merely characterizes the change rule of the fatigue life N with the length L of the effective section in the range of 1 mm≤L≤35 mm, which may not provide accurate guidance for selection of the wall thickness t of the pipe fittings. Therefore, it is urgent to determine the joint influence of the length L of the effective section, the wall thickness t and the outer diameter D on the fatigue life N to achieve both fatigue life and cost control.

Based on this demand, by continuing to analyze the data in Table 1, it is found that the outer diameter D not only affects the fatigue life N, but also affects the change rate of the fatigue life N. Specifically, the change rate of the fatigue life N decreases monotonically with the outer diameter D as a power function. According to this analysis result and combined with the influence of the length L of the effective section, the wall thickness t and the outer diameter D on the fatigue life N, the following fatigue life model of the test products was constructed after simulation calculation:

$$N = \frac{k * t * ( {D}^{4} - {d}^{4} )}{\sqrt{LD} * {D}^{2}}$$

$$k = A * 1 {0}^{6} * {D}^{α} ;$$

where k denotes the fatigue life coefficient of the combined pipe fitting, which characterizes the change rate of the fatigue life N; D denotes the outer diameter of the third pipe fitting; d denotes the inner diameter of the third pipe fitting; t denotes the wall thickness of the third pipe fitting, and t=(D−d)/2; L denotes the length of the effective section of the third pipe fitting; 7≤A≤10; and α is a negative value and −2≤α≤−1.

In this embodiment, the fluctuation differential pressure in the test products is ΔP≤4 MPa, the fluctuation frequency is 0.2 Hz≤f≤0.3 Hz, and the power function fitting relationship between the fatigue life coefficient k of the combined pipe fitting and D is as follows:

$$k = 9 E + 06 {D}^{α} , where α = - 1.5 \pm 0.3 .$$

Preferably, k=9E+06D^{-1.643}. However, the present invention does not specifically limit the coefficients A and α in the power function. In other embodiments, the values of the coefficients A and α may also be other values within the ranges of 7≤A≤10 and −2≤α≤−1 for different fatigue life requirement standards and test conditions.

After obtaining the above fatigue life model, the fatigue life model needs to be verified in order to determine the credibility of the fatigue life model. The outer diameters D, the wall thicknesses t, and the lengths L of the effective sections of the 150 test products in Table 1 were substituted into the above fatigue life model to obtain the calculated fatigue life N′ of each test product, and an error between the actual fatigue life N (the fatigue life in Table 1) and the calculated fatigue life N′ was calculated, where the error is equal to (N−N′)/N. The simulation data was summarized to be shown in Table 2, and the error between the actual fatigue life N and the calculated fatigue life N′ of all test products was within 5%. The error result proves that the above fatigue life model has sufficient credibility and may provide accurate guidance for the model selection of the pipe fitting during product development, thus greatly shortening the product development cycle, improving development efficiency and reducing development costs.

This embodiment takes the requirements of the fatigue test for the fatigue life N in EE.5 of standard GB 4706.32-2012/IEC 60335-2-40:2005 (the fatigue life N needs to reach 2.5*10⁵ times) as an example, and it is described in detail that the length L of the effective section is adjusted in the range of 1 mm≤L≤35 mm to select a smaller outer diameter D by using the above fatigue life model. However, the present invention does not limit this in any way. In other embodiments, the fatigue life of the combined pipe fitting may also be determined according to the needs of different air conditioning manufacturers.

Specifically, as shown in Table 3:

(1) For the two control groups with the inner diameter d=6 mm, the actual fatigue life N is required to reach 2.5*10⁵ times, and through the calculation of the above fatigue life model, the following may be obtained:

Control group 1: when D=7 mm and L≤35 mm, the calculated fatigue life N′ satisfies the requirements.

Control group 2: when D=6.8 mm and L≤15 mm, the calculated fatigue life N′ satisfies the requirements.

The test product corresponding to control group 2 has a smaller outer diameter D (i.e., the wall thickness t is smaller); and accordingly, the cost thereof may be lower. Therefore, the test product corresponding to control group 2 is selected as the optimal model selection product, and the length L of the effective section thereof is controlled to be 1 mm-15 mm to minimize the cost of the combined pipe fitting under the condition of satisfying the standard requirements for the fatigue life.

(2) For the two control groups with the inner diameter d=8.52 mm, the actual fatigue life N is required to reach 2.5*10⁵ times, and through the calculation of the above fatigue life model, the following may be obtained:

Control group 1: when D=9.52 mm and L≤20 mm, the calculated fatigue life N′ satisfies the requirements.

Control group 2: when D=9.32 mm and L≤10 mm, the calculated fatigue life N′ satisfies the requirements.

Similarly, the test product corresponding to control group 2 is selected as the optimal model selection product, and the length L of the effective section thereof is controlled to be 1 mm-10 mm.

(3) For the two control groups with the inner diameter d=11.5 mm, the actual fatigue life N is required to reach 2.5*10⁵ times, and through the calculation of the above fatigue life model, the following may be obtained:

Control group 1: when D=12.7 mm and L≤20 mm, the calculated fatigue life N′ satisfies the requirements.

Control group 2: when D=12.5 mm and L≤10 mm, the calculated fatigue life N′ satisfies the requirements.

Similarly, the test product corresponding to control group 2 is selected as the optimal model selection product, and the length L of the effective section thereof is controlled to be 1 mm-10 mm.

(4) For the two control groups with the inner diameter d=26.4 mm, the actual fatigue life N is required to reach 2.5*10⁵ times, and through the calculation of the above fatigue life model, the following may be obtained:

Control group 1: when D=28.6 mm and L≤35 mm, the calculated fatigue life N′ satisfies the requirements.

Control group 2: when D=28.2 mm and L≤20 mm, the calculated fatigue life N′ satisfies the requirements.

Similarly, the test product corresponding to control group 2 is selected as the optimal model selection product, and the length of the effective section thereof is controlled to be 1 mm-20 mm.

(5) For the two control groups with the inner diameter d=32.7 mm, the actual fatigue life N is required to reach 2.5*10⁵ times, and through the calculation of the above fatigue life model, the following may be obtained:

Control group 1: when D=35 mm and L≤35 mm, the calculated fatigue life N′ satisfies the requirements.

Control group 2: when D=34.5 mm and L≤10 mm, the calculated fatigue life N′ satisfies the requirements.

Similarly, the test product corresponding to control group 2 is selected as the optimal model selection product, and the length L of the effective section thereof is controlled to be 1 mm-10 mm.

As mentioned above, at present, one way of product model selection based on the requirements for the fatigue life is to give a variety of combinations by designers according to experience and conduct comparative testing to determine the relatively optimal product model, which not only relies heavily on the experience of the designers, but also has problems such as long model selection cycle and incompatibility between model selection and cost control. Another way of model selection is based on the Goodman diagram, which has high requirements on the ability of the designers, so this way is also difficult to promote and use in the industry. In the combined pipe fitting according to this embodiment, the length L of the effective section, the wall thickness t, and the outer diameter D of the third pipe fitting satisfy the fatigue life model with the fatigue life N within the range of 1 mm≤L≤35 mm. Therefore, in application, the designers only need to substitute the length L of the effective section, the wall thickness t and the outer diameter D of the third pipe fitting 3 to calculate whether the fatigue life of the combined pipe fitting under this parameter combination satisfies the standard requirements. For qualified model selection products satisfying the fatigue life requirements, the minimum outer diameter D may be selected as the optimal model selection product, so model selection is easy, fast and accurate, and it is very convenient for the designers to use.

Based on the above analysis, it can be concluded that the fatigue life of the combined pipe fitting 10 may be prolonged by decreasing the length L of the effective section. However, in an air conditioning pipeline, since the distribution position of each pipe fitting is basically determined, in order to connect two pipe fittings to each other, a connecting pipe in the middle needs to have a sufficient length. For example, in the case of a gas collecting pipe, the length of distribution branch pipes thereof needs to satisfy a connecting spacing between pipe fittings. Therefore, in order to make up for a distance difference caused by the adjustment of the length L of the effective section on the third pipe fitting 3, the combined pipe fitting according to this embodiment is additionally provided with the second pipe fitting 2 between the first pipe fitting 1 and the third pipe fitting 3, and the length of the second pipe fitting 2 may be adjusted to make up for the adjustment distance of the length L of the effective section, so as to ensure that the overall length of the second pipe fitting 2 and the third pipe fitting 3 after welding satisfies the requirements of the connecting spacing. Further, in this embodiment, the second pipe fitting 2 is a stainless steel pipe. Compared to a copper pipe, the stainless steel pipe is not only lower in cost but also has a grain size that remains substantially unchanged after furnace brazing. Therefore, the design of the combined pipe fitting only needs to focus on the influence of the third pipe fitting 3 on the fatigue life N, which further reduces the difficulty of type selection design of the pipe fitting.

In this embodiment, the effective section 32 of the third pipe fitting 3 is a straight pipe section in which both inner and outer diameters remain substantially unchanged and a central axis is approximately straight. Therefore, in the fatigue life model described above, D denotes the outer diameter within the length L of the effective section, d denotes the inner diameter within the length L of the effective section, t denotes the wall thickness within the length L of the effective section, and k denotes the fatigue life coefficient of the combined pipe fitting and decreases monotonically with D as a power function. However, the present invention does not limit the structure of the effective section of the third pipe fitting in any way. In other embodiments, the effective section of the third pipe fitting may also be a reducing pipe fitting with varying inner and/or outer diameters. In this case, in the above fatigue life formula, D denotes the maximum outer diameter within the length L of the effective section, d denotes the inner diameter corresponding to D within the length L of the effective section, and t denotes the minimum wall thickness within the length L of the effective section.

Preferably, the maximum outer diameter of the effective section 32 is set to be 4.2 mm≤D≤35 mm; and the wall thickness of the effective section 32 is set to be 0.3 mm≤t≤1.65 mm. However, the present invention does not limit this in any way.

In this embodiment, the third pipe fitting 3 is a straight pipe, and the first connecting section 31, the effective section 32 and the second connecting section 33 are basically the same in inner diameter, outer diameter and wall thickness. The second connecting section 33 of the third pipe fitting 3 is sleeved with the external pipe fitting 20, and a sleeving length H satisfies: H=PD, where 0.5≤β≤1.5, and D denotes the outer diameter of the length L of the effective section. The sleeving length H refers to a distance from a joint position of the second connecting section 33 and the external pipe fitting 20 to an end face of the second connecting section 33, and the joint position refers to a position where an end face of a connecting end of the external pipe fitting 20 is located. However, the present invention does not limit the connecting manner of the second connecting section in any way.

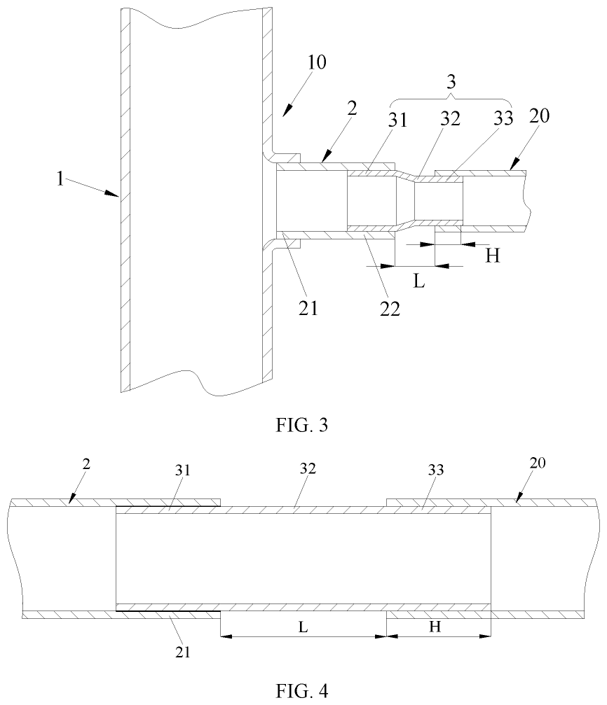

In other embodiments, as shown in FIG. 2, the second connecting section 33 may also be flared to be connected to the external pipe fitting 20 in a sleeving manner. In this case, the strength of the combined pipe fitting at the second connecting section 33 may be determined by the second connecting section 33 and the external pipe fitting 20 overlapping the second connecting section, which may be very high; and the wall thickness of the second connecting section 33 is less than or equal to the wall thickness of the effective section 32 to further reduce the cost. Alternatively, as shown in FIG. 3, the second connecting section 33 may also be necked to be sleeved with the external pipe fitting 20, and the wall thickness of the second connecting section 33 is greater than or equal to the wall thickness of the effective section 32. Alternatively, in other embodiments, the first connecting section 31 of the third pipe fitting 3 may also be necked to be sleeved with the second end 22 of the second pipe fitting 2, and the wall thickness of the first connecting section 31 is less than or equal to the wall thickness of the effective section 32.

Although this embodiment is illustrated by the example of the first pipe fitting 1, the second pipe fitting 2 and the third pipe fitting 3 being welded in one piece by furnace brazing, the present invention does not limit this in any way. In other embodiments, the first pipe fitting, the second pipe fitting and the third pipe fitting may also be welded in other manner.

### Embodiment 2

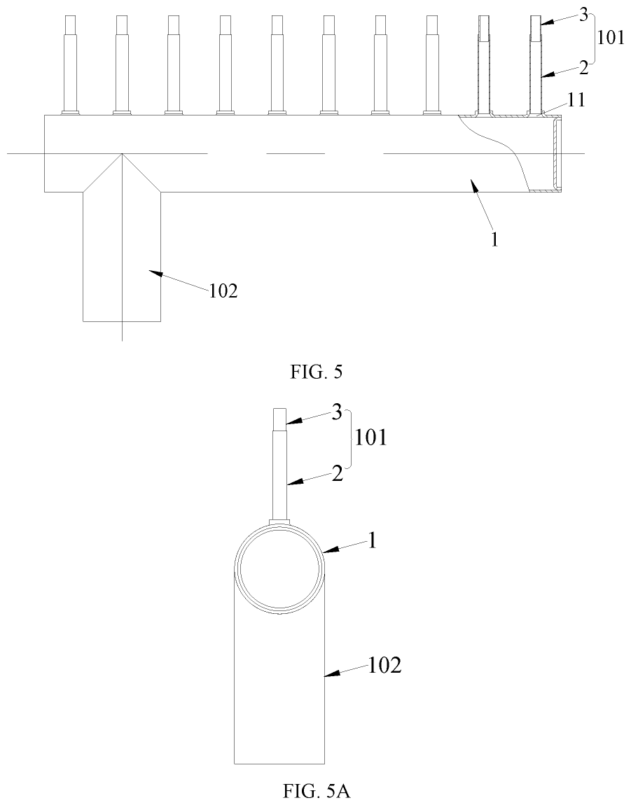

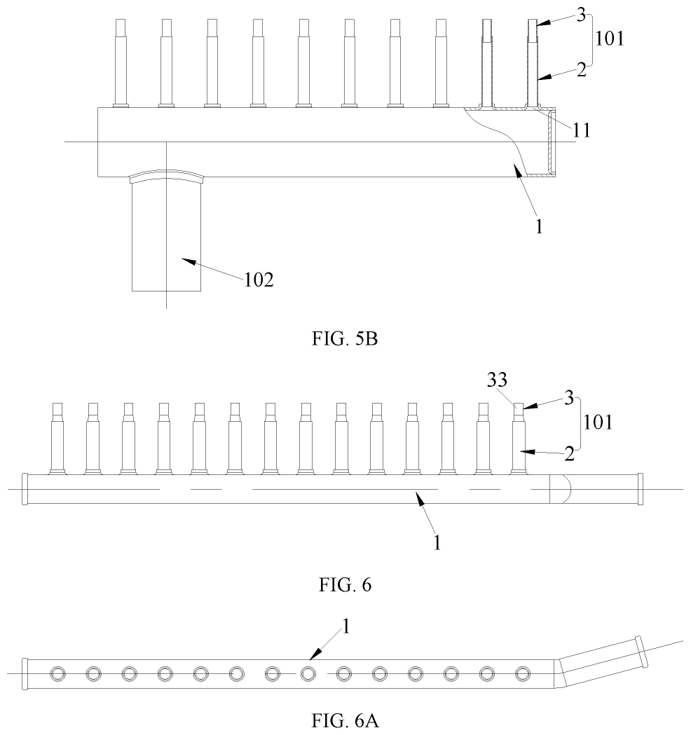

This embodiment is basically the same as Embodiment 1 and variations thereof, with the difference that, as shown in FIG. 5 and FIG. 5A, a combined pipe fitting according to this embodiment includes a first pipe fitting 1, a plurality of second pipe fittings 2, a plurality of third pipe fittings 3, and a collecting pipe 102. The first pipe fitting 1 is a main pipe, and the second pipe fittings 2 and the corresponding third pipe fittings 3 are combined and welded to form distribution pipes 101. Both ends of the first pipe fitting 1 are closed, and a plurality of connecting holes 11 and a collecting pipe hole are provided in a pipe wall of the first pipe fitting. First ends of the second pipe fittings 2 are connected to the connecting holes 11 in a sleeved manner respectively, and the collecting pipe 102 is connected to the collecting pipe hole in a sleeved manner. The combined pipe fitting may achieve collection and distribution of gases or liquids, and may be applied as a gas collecting pipe or a liquid collecting pipe. However, the present invention does not limit the connecting manner of the first pipe fitting and the second pipe fittings in any way. In other embodiments, the first ends 21 of the second pipe fittings 2 may also be sleeved with an end of the first pipe fitting 1. FIG. 5B is a schematic structural diagram of a combined pipe fitting with a structure similar to that in FIG. 5 according to other embodiments of the present invention, with the difference that in FIG. 5B, the collecting pipe hole in the pipe wall of the first pipe fitting 1 is a flanged hole, and the collecting pipe 102 is sleeved with the flanged collecting pipe hole.

In this embodiment, the third pipe fittings 3 are straight pipes, first connecting sections 31 of the third pipe fittings 3 are sleeved with second ends 22 of the second pipe fittings, and second connecting sections 33 of the third pipe fittings 3 are sleeved with external pipe fittings. After welding of the first pipe fitting 1, the second pipe fittings 2, and the third pipe fittings 3, the length L of the effective sections, the wall thickness t, and the outer diameter D of the third pipe fittings 3 have the same relationship with the fatigue life N as in Embodiment 1, which will not be repeated herein.

In this embodiment, the collecting pipe 102 is an integral pipe fitting. However, the present invention does not limit this in any way. In other embodiments, the collecting pipe may also be formed by welding and combining a second pipe fitting and a third pipe fitting; similarly, in this case, the length L of the effective sections, the wall thickness t, and the outer diameter D of the third pipe fittings have the same relationship with the fatigue life N as in Embodiment 1.

This embodiment is illustrated by way of example with the structure of the gas collecting pipe or liquid collecting pipe shown in FIG. 5 and FIG. 5A. However, the present invention does not limit this in any way. In other embodiments, as shown in FIG. 6 and FIG. 6A, there is no collecting pipe on the gas collecting pipe or liquid collecting pipe. One end of the first pipe fitting 1 is closed, and the other end thereof serves as the collecting pipe. In this structure, the second pipe fittings 2 and the corresponding third pipe fittings 3 are combined and welded to form the distribution pipes 101. The first ends 21 of the second pipe fittings 2 are sleeved with the connecting holes 11 in the pipe wall of the first pipe fitting 1; and the second connecting sections 33 of the third pipe fittings 3 are necked to be inserted into the external pipe fittings. Similarly, in this combined structure, after welding of the first pipe fitting 1, the second pipe fittings 2, and the third pipe fittings 3, the length L of the effective sections, the wall thickness t, and the outer diameter D of the third pipe fittings 3 have the same relationship with the fatigue life N as in Embodiment 1, which will not be repeated herein.

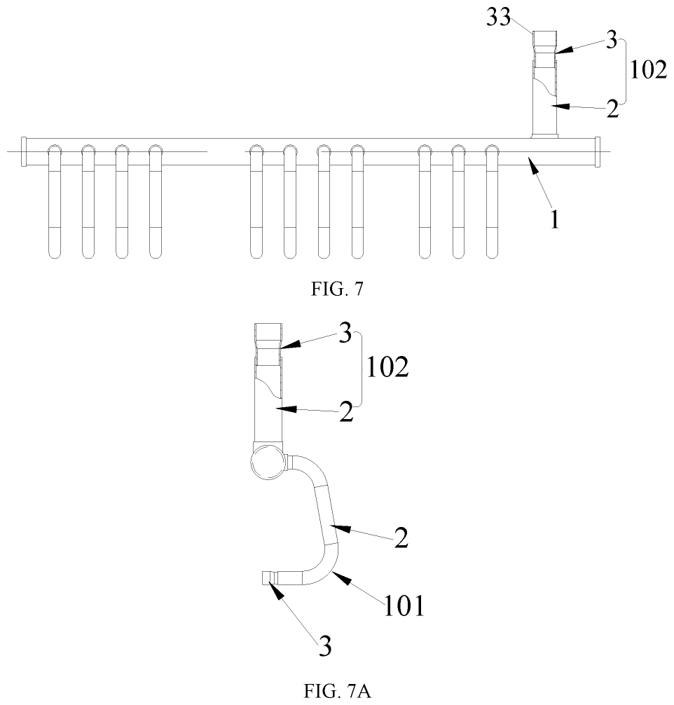

FIG. 7 and FIG. 7A show a combined pipe fitting structure that may be used as a gas collecting pipe or liquid collecting pipe according to another embodiment of the present invention. The combined pipe fitting structure also includes a first pipe fitting 1, a plurality of second pipe fittings 2, and a plurality of third pipe fittings 3. The first pipe fitting 1 serves as a main pipe, and each distribution pipe 101 and a collecting pipe 102 are formed by welding the second pipe fittings 2 and the third pipe fittings 3 and then combining same; and the distribution pipes 101 formed by welding the second pipe fittings 2 and the third pipe fittings 3 are in the form of bent pipes. However, the present invention does not limit this in any way. In this structure, the second connecting sections 33 of the third pipe fittings 3 are flared to be connected to external pipe fittings in a sleeving manner. Similarly, in this combined structure, after welding of the first pipe fitting 1, the second pipe fittings 2, and the third pipe fittings 3, the length L of the effective sections, the wall thickness t, and the outer diameter D of the third pipe fittings 3 have the same relationship with the fatigue life N as in Embodiment 1, which will not be repeated herein.

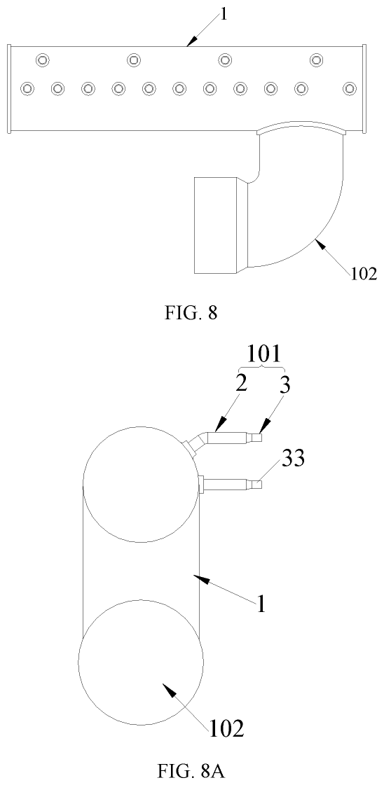

FIG. 8 and FIG. 8A show a combined pipe fitting structure that may be used as a gas collecting pipe or liquid collecting pipe according to another embodiment of the present invention. In this structure, the collecting pipe 102 is an integral bent pipe, each distribution pipe 101 includes a second pipe fitting 2 and a third pipe fitting 3, and a second connecting section 33 of the third pipe fitting 3 is necked to be inserted into an external pipe fitting. Similarly, in this combined structure, after welding of the first pipe fitting 1, the second pipe fittings 2, and the third pipe fittings 3, the length L of the effective sections, the wall thickness t, and the outer diameter D of the third pipe fittings 3 have the same relationship with the fatigue life N as in Embodiment 1, which will not be repeated herein.

Correspondingly, this embodiment further provides an air conditioning system pipeline. The air conditioning system pipeline includes the combined pipe fitting 10 according to this embodiment, and a plurality of external pipe fittings 20. The plurality of external pipe fittings 20 are welded to second connecting sections 33 of third pipe fittings 3 on distribution pipes 101 respectively.

In summary, the combined pipe fitting according to this embodiment satisfies the requirements for the fatigue life N by accurate design of the length L of the effective section of the third pipe fitting; and in application, the appropriate length L of the effective section is determined on the basis of the given outer diameter D and wall thickness t of the effective section to clarify the product model selection before testing, thereby greatly increasing the development speed and reducing the market risk. Further, the fatigue life N of the combined pipe fitting may also be predicted on the basis of the fatigue life model established by fitting, and the economically optimal outer diameter of the third pipe fitting is selected under the premise of ensuring that the fatigue life N satisfies the requirements, so as to achieve accurate cost control.

Although the present invention has been described with reference to the above preferred embodiments, the present invention is not limited thereto. Any person skilled in the art may make slight changes and embellishments without departing from the spirit and scope of the present invention, so that the scope of protection of the present invention shall be subject to the scope of protection required by the claims.

In the following tables, the unit of the fatigue life is times; the units of the wall thickness t, the length L, the outer diameter D, and the inner diameter d are mm; and the error in Table 2 refers to an error between the actual fatigue life N and the calculated fatigue life N′ of the corresponding test product in the corresponding test group and simulation group in Table 1 and Table 2.

TABLE 1

| | | | | |
|---|---|---|---|---|
| Actual | Wall | | Outer | Inner |
| fatigue | thickness | Length | diameter | diameter |
| life*10\hat{ }5 | t | L | D | d |

Test group 1 D = 7

| | | | | | |
|---|---|---|---|---|---|
| First | 3.83 | 0.65 | 40.00 | 7.00 | 5.70 |
| sub-test | 4.10 | 0.65 | 35.00 | 7.00 | 5.70 |
| group | 4.43 | 0.65 | 30.00 | 7.00 | 5.70 |
| | 4.85 | 0.65 | 25.00 | 7.00 | 5.70 |
| | 5.42 | 0.65 | 20.00 | 7.00 | 5.70 |
| | 6.26 | 0.65 | 15.00 | 7.00 | 5.70 |
| | 7.67 | 0.65 | 10.00 | 7.00 | 5.70 |
| | 10.85 | 0.65 | 5.00 | 7.00 | 5.70 |
| | 17.17 | 0.65 | 2.00 | 7.00 | 5.70 |
| | 24.31 | 0.65 | 1.00 | 7.00 | 5.70 |
| Second | 3.52 | 0.60 | 36.00 | 7.00 | 5.80 |
| sub-test | 3.57 | 0.60 | 35.00 | 7.00 | 5.80 |
| group | 3.85 | 0.60 | 30.00 | 7.00 | 5.80 |
| | 4.23 | 0.60 | 25.00 | 7.00 | 5.80 |
| | 4.73 | 0.60 | 20.00 | 7.00 | 5.80 |
| | 5.46 | 0.60 | 15.00 | 7.00 | 5.80 |
| | 6.69 | 0.60 | 10.00 | 7.00 | 5.80 |
| | 9.46 | 0.60 | 5.00 | 7.00 | 5.80 |
| | 14.95 | 0.60 | 2.00 | 7.00 | 5.80 |
| | 21.15 | 0.60 | 1.00 | 7.00 | 5.80 |
| Third | 2.56 | 0.50 | 36.00 | 7.00 | 6.00 |
| sub-test | 2.59 | 0.50 | 35.00 | 7.00 | 6.00 |
| group | 2.80 | 0.50 | 30.00 | 7.00 | 6.00 |
| | 3.07 | 0.50 | 25.00 | 7.00 | 6.00 |
| | 3.43 | 0.50 | 20.00 | 7.00 | 6.00 |
| | 3.96 | 0.50 | 15.00 | 7.00 | 6.00 |
| | 4.85 | 0.50 | 10.00 | 7.00 | 6.00 |
| | 6.86 | 0.50 | 5.00 | 7.00 | 6.00 |
| | 10.85 | 0.50 | 2.00 | 7.00 | 6.00 |
| | 15.37 | 0.50 | 1.00 | 7.00 | 6.00 |

Test group 2 D = 9.52

| | | | | | |
|---|---|---|---|---|---|
| First | 3.65 | 0.70 | 36.00 | 9.52 | 8.12 |
| sub-test | 3.70 | 0.70 | 35.00 | 9.52 | 8.12 |
| group | 4.00 | 0.70 | 30.00 | 9.52 | 8.12 |
| | 4.36 | 0.70 | 25.00 | 9.52 | 8.12 |
| | 4.89 | 0.70 | 20.00 | 9.52 | 8.12 |
| | 5.65 | 0.70 | 15.00 | 9.52 | 8.12 |
| | 6.92 | 0.70 | 10.00 | 9.52 | 8.12 |
| | 9.78 | 0.70 | 5.00 | 9.52 | 8.12 |
| | 15.46 | 0.70 | 2.00 | 9.52 | 8.12 |
| | 21.86 | 0.70 | 1.00 | 9.52 | 8.12 |
| Second | 2.76 | 0.60 | 36.00 | 9.52 | 8.32 |
| sub-test | 2.79 | 0.60 | 35.00 | 9.52 | 8.32 |
| group | 3.01 | 0.60 | 30.00 | 9.52 | 8.32 |
| | 3.32 | 0.60 | 25.00 | 9.52 | 8.32 |
| | 3.71 | 0.60 | 20.00 | 9.52 | 8.32 |
| | 4.28 | 0.60 | 15.00 | 9.52 | 8.32 |
| | 5.25 | 0.60 | 10.00 | 9.52 | 8.32 |
| | 7.42 | 0.60 | 5.00 | 9.52 | 8.32 |
| | 11.72 | 0.60 | 2.00 | 9.52 | 8.32 |
| | 16.59 | 0.60 | 1.00 | 9.52 | 8.32 |
| Third | 1.97 | 0.50 | 36.00 | 9.52 | 8.52 |
| sub-test | 2.00 | 0.50 | 35.00 | 9.52 | 8.52 |
| group | 2.16 | 0.50 | 30.00 | 9.52 | 8.52 |
| | 2.37 | 0.50 | 25.00 | 9.52 | 8.52 |
| | 2.65 | 0.50 | 20.00 | 9.52 | 8.52 |
| | 3.07 | 0.50 | 15.00 | 9.52 | 8.52 |
| | 3.75 | 0.50 | 10.00 | 9.52 | 8.52 |
| | 5.31 | 0.50 | 5.00 | 9.52 | 8.52 |
| | 8.40 | 0.50 | 2.00 | 9.52 | 8.52 |
| | 11.88 | 0.50 | 1.00 | 9.52 | 8.52 |

Test group 3 D = 12.7

| | | | | | |
|---|---|---|---|---|---|
| First | 3.66 | 0.85 | 40.00 | 12.70 | 11.00 |
| sub-test | 3.91 | 0.85 | 35.00 | 12.70 | 11.00 |
| group | 4.23 | 0.85 | 30.00 | 12.70 | 11.00 |
| | 4.62 | 0.85 | 25.00 | 12.70 | 11.00 |
| | 5.18 | 0.85 | 20.00 | 12.70 | 11.00 |
| | 5.98 | 0.85 | 15.00 | 12.70 | 11.00 |
| | 7.32 | 0.85 | 10.00 | 12.70 | 11.00 |
| | 10.34 | 0.85 | 5.00 | 12.70 | 11.00 |
| | 16.35 | 0.85 | 2.00 | 12.70 | 11.00 |
| | 23.18 | 0.85 | 1.00 | 12.70 | 11.00 |
| Second | 2.24 | 0.65 | 40.00 | 12.70 | 11.40 |
| sub-test | 2.40 | 0.65 | 35.00 | 12.70 | 11.40 |
| group | 2.59 | 0.65 | 30.00 | 12.70 | 11.40 |
| | 2.84 | 0.65 | 25.00 | 12.70 | 11.40 |
| | 3.17 | 0.65 | 20.00 | 12.70 | 11.40 |
| | 3.67 | 0.65 | 15.00 | 12.70 | 11.40 |
| | 4.48 | 0.65 | 10.00 | 12.70 | 11.40 |
| | 6.36 | 0.65 | 5.00 | 12.70 | 11.40 |
| | 10.04 | 0.65 | 2.00 | 12.70 | 11.40 |
| | 14.22 | 0.65 | 1.00 | 12.70 | 11.40 |
| Third | 1.93 | 0.60 | 40.00 | 12.70 | 11.50 |
| sub-test | 2.07 | 0.60 | 35.00 | 12.70 | 11.50 |
| group | 2.23 | 0.60 | 30.00 | 12.70 | 11.50 |
| | 2.45 | 0.60 | 25.00 | 12.70 | 11.50 |
| | 2.74 | 0.60 | 20.00 | 12.70 | 11.50 |
| | 3.16 | 0.60 | 15.00 | 12.70 | 11.50 |
| | 3.87 | 0.60 | 10.00 | 12.70 | 11.50 |
| | 5.47 | 0.60 | 5.00 | 12.70 | 11.50 |
| | 8.66 | 0.60 | 2.00 | 12.70 | 11.50 |
| | 12.25 | 0.60 | 1.00 | 12.70 | 11.50 |

Test group 4 D = 28.6

| | | | | | |
|---|---|---|---|---|---|
| First | 3.21 | 1.20 | 40.00 | 28.60 | 26.20 |
| sub-test | 3.43 | 1.20 | 35.00 | 28.60 | 26.20 |
| group | 3.71 | 1.20 | 30.00 | 28.60 | 26.20 |
| | 4.06 | 1.20 | 25.00 | 28.60 | 26.20 |
| | 4.53 | 1.20 | 20.00 | 28.60 | 26.20 |
| | 5.25 | 1.20 | 15.00 | 28.60 | 26.20 |
| | 6.43 | 1.20 | 10.00 | 28.60 | 26.20 |
| | 9.08 | 1.20 | 5.00 | 28.60 | 26.20 |
| | 14.37 | 1.20 | 2.00 | 28.60 | 26.20 |
| | 20.33 | 1.20 | 1.00 | 28.60 | 26.20 |
| Second | 2.97 | 1.15 | 40.00 | 28.60 | 26.30 |
| sub-test | 3.18 | 1.15 | 35.00 | 28.60 | 26.30 |
| group | 3.42 | 1.15 | 30.00 | 28.60 | 26.30 |
| | 3.75 | 1.15 | 25.00 | 28.60 | 26.30 |
| | 4.18 | 1.15 | 20.00 | 28.60 | 26.30 |
| | 4.83 | 1.15 | 15.00 | 28.60 | 26.30 |
| | 5.93 | 1.15 | 10.00 | 28.60 | 26.30 |
| | 8.38 | 1.15 | 5.00 | 28.60 | 26.30 |
| | 13.28 | 1.15 | 2.00 | 28.60 | 26.30 |
| | 18.78 | 1.15 | 1.00 | 28.60 | 26.30 |
| Third | 2.73 | 1.10 | 40.00 | 28.60 | 26.40 |
| sub-test | 2.91 | 1.10 | 35.00 | 28.60 | 26.40 |
| group | 3.17 | 1.10 | 30.00 | 28.60 | 26.40 |
| | 3.45 | 1.10 | 25.00 | 28.60 | 26.40 |
| | 3.86 | 1.10 | 20.00 | 28.60 | 26.40 |
| | 4.45 | 1.10 | 15.00 | 28.60 | 26.40 |
| | 5.46 | 1.10 | 10.00 | 28.60 | 26.40 |
| | 7.72 | 1.10 | 5.00 | 28.60 | 26.40 |
| | 12.21 | 1.10 | 2.00 | 28.60 | 26.40 |
| | 17.30 | 1.10 | 1.00 | 28.60 | 26.40 |

Test group 5 D = 35

| | | | | | |
|---|---|---|---|---|---|
| First | 4.93 | 1.65 | 36.00 | 35.00 | 31.70 |
| sub-test | 5.02 | 1.65 | 35.00 | 35.00 | 31.70 |
| group | 5.43 | 1.65 | 30.00 | 35.00 | 31.70 |
| | 5.94 | 1.65 | 25.00 | 35.00 | 31.70 |
| | 6.61 | 1.65 | 20.00 | 35.00 | 31.70 |
| | 7.63 | 1.65 | 15.00 | 35.00 | 31.70 |
| | 9.38 | 1.65 | 10.00 | 35.00 | 31.70 |
| | 13.28 | 1.65 | 5.00 | 35.00 | 31.70 |
| | 20.99 | 1.65 | 2.00 | 35.00 | 31.70 |
| | 29.81 | 1.65 | 1.00 | 35.00 | 31.70 |
| Second | 3.39 | 1.35 | 36.00 | 35.00 | 32.30 |
| sub-test | 3.44 | 1.35 | 35.00 | 35.00 | 32.30 |
| group | 3.71 | 1.35 | 30.00 | 35.00 | 32.30 |
| | 4.06 | 1.35 | 25.00 | 35.00 | 32.30 |
| | 4.55 | 1.35 | 20.00 | 35.00 | 32.30 |
| | 5.26 | 1.35 | 15.00 | 35.00 | 32.30 |
| | 6.46 | 1.35 | 10.00 | 35.00 | 32.30 |
| | 9.09 | 1.35 | 5.00 | 35.00 | 32.30 |
| | 14.41 | 1.35 | 2.00 | 35.00 | 32.30 |
| | 20.29 | 1.35 | 1.00 | 35.00 | 32.30 |
| Third | 2.51 | 1.15 | 36.00 | 35.00 | 32.70 |
| sub-test | 2.54 | 1.15 | 35.00 | 35.00 | 32.70 |
| group | 2.74 | 1.15 | 30.00 | 35.00 | 32.70 |
| | 3.01 | 1.15 | 25.00 | 35.00 | 32.70 |
| | 3.36 | 1.15 | 20.00 | 35.00 | 32.70 |
| | 3.88 | 1.15 | 15.00 | 35.00 | 32.70 |
| | 4.74 | 1.15 | 10.00 | 35.00 | 32.70 |
| | 6.72 | 1.15 | 5.00 | 35.00 | 32.70 |
| | 10.62 | 1.15 | 2.00 | 35.00 | 32.70 |
| | 15.02 | 1.15 | 1.00 | 35.00 | 32.70 |

TABLE 2

| | | | | | |
|---|---|---|---|---|---|
| Calculated | Wall | | Outer | Inner | |
| fatigue | thick- | Length | diam- | diam- | |
| life*10\hat{ }5 | ness t | L | eter D | eter d | Error |

Simulation group 1 D = 7

| | | | | | | |
|---|---|---|---|---|---|---|
| First | 3.92 | 0.65 | 40.00 | 7.00 | 5.70 | 2.35% |
| sub- | 4.19 | 0.65 | 35.00 | 7.00 | 5.70 | 2.20% |
| simulation | 4.53 | 0.65 | 30.00 | 7.00 | 5.70 | 2.26% |
| group | 4.96 | 0.65 | 25.00 | 7.00 | 5.70 | 2.27% |
| | 5.55 | 0.65 | 20.00 | 7.00 | 5.70 | 2.40% |
| | 6.41 | 0.65 | 15.00 | 7.00 | 5.70 | 2.40% |
| | 7.85 | 0.65 | 10.00 | 7.00 | 5.70 | 2.35% |
| | 11.10 | 0.65 | 5.00 | 7.00 | 5.70 | 2.30% |
| | 17.55 | 0.65 | 2.00 | 7.00 | 5.70 | 2.21% |
| | 24.94 | 0.65 | 1.00 | 7.00 | 5.70 | 2.59% |
| Second | 3.60 | 0.60 | 36.00 | 7.00 | 5.80 | 2.27% |
| sub- | 3.65 | 0.60 | 35.00 | 7.00 | 5.80 | 2.24% |
| simulation | 3.95 | 0.60 | 30.00 | 7.00 | 5.80 | 2.60% |
| group | 4.32 | 0.60 | 25.00 | 7.00 | 5.80 | 2.13% |
| | 4.83 | 0.60 | 20.00 | 7.00 | 5.80 | 2.11% |
| | 5.58 | 0.60 | 15.00 | 7.00 | 5.80 | 2.20% |
| | 6.83 | 0.60 | 10.00 | 7.00 | 5.80 | 2.09% |
| | 9.67 | 0.60 | 5.00 | 7.00 | 5.80 | 2.22% |
| | 15.28 | 0.60 | 2.00 | 7.00 | 5.80 | 2.21% |
| | 21.72 | 0.60 | 1.00 | 7.00 | 5.80 | 2.70% |
| Third | 2.61 | 0.50 | 36.00 | 7.00 | 6.00 | 1.95% |
| sub- | 2.65 | 0.50 | 35.00 | 7.00 | 6.00 | 2.32% |
| simulation | 2.86 | 0.50 | 30.00 | 7.00 | 6.00 | 2.14% |
| group | 3.14 | 0.50 | 25.00 | 7.00 | 6.00 | 2.28% |
| | 3.51 | 0.50 | 20.00 | 7.00 | 6.00 | 2.33% |
| | 4.05 | 0.50 | 15.00 | 7.00 | 6.00 | 2.27% |
| | 4.96 | 0.50 | 10.00 | 7.00 | 6.00 | 2.27% |
| | 7.01 | 0.50 | 5.00 | 7.00 | 6.00 | 2.19% |
| | 11.09 | 0.50 | 2.00 | 7.00 | 6.00 | 2.21% |
| | 15.76 | 0.50 | 1.00 | 7.00 | 6.00 | 2.54% |

Simulation group 2 D = 9.52

| | | | | | | |
|---|---|---|---|---|---|---|
| First | 3.58 | 0.70 | 36.00 | 9.52 | 8.12 | −1.92% |
| sub- | 3.63 | 0.70 | 35.00 | 9.52 | 8.12 | −1.89% |
| simulation | 3.92 | 0.70 | 30.00 | 9.52 | 8.12 | −2.00% |
| group | 4.30 | 0.70 | 25.00 | 9.52 | 8.12 | −1.38% |
| | 4.80 | 0.70 | 20.00 | 9.52 | 8.12 | −1.84% |
| | 5.55 | 0.70 | 15.00 | 9.52 | 8.12 | −1.77% |
| | 6.79 | 0.70 | 10.00 | 9.52 | 8.12 | −1.88% |
| | 9.61 | 0.70 | 5.00 | 9.52 | 8.12 | −1.74% |
| | 15.19 | 0..70 | 2.00 | 9.52 | 8.12 | −1.75% |
| | 21.49 | 0.70 | 1.00 | 9.52 | 8.12 | −1.69% |
| Second | 2.72 | 0.60 | 36.00 | 9.52 | 8.32 | −1.45% |
| sub- | 2.76 | 0.60 | 35.00 | 9.52 | 8.32 | −1.08% |
| simulation | 2.98 | 0.60 | 30.00 | 9.52 | 8.32 | −1.00% |
| group | 3.26 | 0.60 | 25.00 | 9.52 | 8.32 | −1.81% |
| | 3.64 | 0.60 | 20.00 | 9.52 | 8.32 | −1.89% |
| | 4.21 | 0.60 | 15.00 | 9.52 | 8.32 | −1.64% |
| | 5.15 | 0.60 | 10.00 | 9.52 | 8.32 | −1.90% |
| | 7.29 | 0.60 | 5.00 | 9.52 | 8.32 | −1.75% |
| | 11.53 | 0.60 | 2.00 | 9.52 | 8.32 | −1.62% |
| | 16.30 | 0.60 | 1.00 | 9.52 | 8.32 | −1.75% |
| Third | 1.95 | 0.50 | 36.00 | 9.52 | 8.52 | −1.02% |
| sub- | 1.98 | 0.50 | 35.00 | 9.52 | 8.52 | −1.00% |
| simulation | 2.13 | 0.50 | 30.00 | 9.52 | 8.52 | −1.39% |
| group | 2.34 | 0.50 | 25.00 | 9.52 | 8.52 | −1.27% |
| | 2.61 | 0.50 | 20.00 | 9.52 | 8.52 | −1.51% |
| | 3.02 | 0.50 | 15.00 | 9.52 | 8.52 | −1.63% |
| | 3.70 | 0.50 | 10.00 | 9.52 | 8.52 | −1.33% |
| | 5.23 | 0.50 | 5.00 | 9.52 | 8.52 | −1.51% |
| | 8.26 | 0.50 | 2.00 | 9.52 | 8.52 | −1.67% |
| | 11.69 | 0.50 | 1.00 | 9.52 | 8.52 | −1.60% |

Simulation group 3 D = 12.7

| | | | | | | |
|---|---|---|---|---|---|---|
| First | 3.68 | 0.85 | 40.00 | 12.70 | 11.00 | 0.55% |
| sub- | 3.93 | 0.85 | 35.00 | 12.70 | 11.00 | 0.51 |
| simulation | 4.25 | 0.85 | 30.00 | 12.70 | 11.00 | 0.47% |
| group | 4.65 | 0.85 | 25.00 | 12.70 | 11.00 | 0.65% |
| | 5.20 | 0.85 | 20.00 | 12.70 | 11.00 | 0.39% |
| | 6.00 | 0.85 | 15.00 | 12.70 | 11.00 | 0.33% |
| | 7.35 | 0.85 | 10.00 | 12.70 | 11.00 | 0.41% |
| | 10.40 | 0.85 | 5.00 | 12.70 | 11.00 | 0.58% |
| | 16.44 | 0.85 | 2.00 | 12.70 | 11.00 | 0.55% |
| Second | 23.25 | 0.85 | 1.00 | 12.70 | 11.00 | 0.30% |
| sub- | 2.26 | 0.65 | 40.00 | 12.70 | 11.40 | 0.890% |
| simulation | 2.41 | 0.65 | 35.00 | 12.70 | 11.40 | 0.42% |
| group | 2.60 | 0.65 | 30.00 | 12.70 | 11.40 | 0.39% |
| | 2.85 | 0.65 | 25.00 | 12.70 | 11.40 | 0.350% |
| | 3.19 | 0.65 | 20.00 | 12.70 | 11.40 | 0.63% |
| | 3.68 | 0.65 | 15.00 | 12.70 | 11.40 | 0.27% |
| | 4.51 | 0.65 | 10.00 | 12.70 | 11.40 | 0.67% |
| | 6.38 | 0.65 | 5.00 | 12.70 | 11.40 | 0.31% |
| | 10.09 | 0.65 | 2.00 | 12.70 | 11.40 | 0.50% |
| | 14.27 | 0.65 | 1.00 | 12.70 | 11.40 | 0.35% |
| Third | 1.95 | 0.60 | 40.00 | 12.70 | 11.50 | 1.04% |
| sub- | 2.08 | 0.60 | 35.00 | 12.70 | 11.50 | 0.48% |
| simulation | 2.25 | 0.60 | 30.00 | 12.70 | 11.50 | 0.90% |
| group | 2.46 | 0.60 | 25.00 | 12.70 | 11.50 | 0.41% |
| | 2.75 | 0.60 | 20.00 | 12.70 | 11.50 | 0.36% |
| | 3.18 | 0.60 | 15.00 | 12.70 | 11.50 | 0.63% |
| | 3.89 | 0.60 | 10.00 | 12.70 | 11.50 | 0.52% |
| | 5.50 | 0.60 | 5.00 | 12.70 | 11.50 | 0.55% |
| | 8.70 | 0.60 | 2.00 | 12.70 | 11.50 | 0.46% |
| | 12.30 | 0.60 | 1.00 | 12.70 | 11.50 | 0.41% |

Simulation group 4 D = 28.6

| | | | | | | |
|---|---|---|---|---|---|---|
| First | 3.13 | 1.20 | 40.00 | 28.60 | 26.20 | −2.49% |
| sub- | 3.34 | 1.20 | 35.00 | 28.60 | 26.20 | −2.62% |
| simulation | 3.61 | 1.20 | 30.00 | 28.60 | 26.20 | −2.70% |
| group | 3.95 | 1.20 | 25.00 | 28.60 | 26.20 | −2.71% |
| | 4.42 | 1.20 | 20.00 | 28.60 | 26.20 | −2.43% |
| | 5.11 | 1.20 | 15.00 | 28.60 | 26.20 | −2.67% |
| | 6.25 | 1.20 | 10.00 | 28.60 | 26.20 | −2.80% |
| | 8.84 | 1.20 | 5.00 | 28.60 | 26.20 | −2.64% |
| | 13.98 | 1.20 | 2.00 | 28.60 | 26.20 | −2.71% |
| | 19.77 | 1.20 | 1.00 | 28.60 | 26.20 | −2.75% |
| Second | 2.89 | 1.15 | 40.00 | 28.60 | 26.30 | −2.69% |
| sub- | 3.09 | 1.15 | 35.00 | 28.60 | 26.30 | −2.83% |
| simulation | 3.33 | 1.15 | 30.00 | 28.60 | 26.30 | −2.63% |
| group | 3.65 | 1.15 | 25.00 | 28.60 | 26.30 | −2.67% |
| | 4.08 | 1.15 | 20.00 | 28.60 | 26.30 | −2.39% |
| | 4.71 | 1.15 | 15.00 | 28.60 | 26.30 | −2.48% |
| | 5.77 | 1.15 | 10.00 | 28.60 | 26.30 | −2.70% |
| | 8.16 | 1.15 | 5.00 | 28.60 | 26.30 | −2.63% |
| | 12.91 | 1.15 | 2.00 | 28.60 | 26.30 | −2.79% |
| | 18.26 | 1.15 | 1.00 | 28.60 | 26.30 | −2.77% |
| Third | 2.65 | 1.10 | 40.00 | 28.60 | 26.40 | −2.93% |
| sub- | 2.84 | 1.10 | 35.00 | 28.60 | 26.40 | −2.41% |
| simulation | 3.07 | 1.10 | 30.00 | 28.60 | 26.40 | −3.15% |
| group | 3.36 | 1.10 | 25.00 | 28.60 | 26.40 | −2.61% |
| | 3.75 | 1.10 | 20.00 | 28.60 | 26.40 | −2.85% |
| | 4.34 | 1.10 | 15.00 | 28.60 | 26.40 | −2.47% |
| | 5.31 | 1.10 | 10.00 | 28.60 | 26.40 | −2.75% |
| | 7.51 | 1.10 | 5.00 | 28.60 | 26.40 | −2.72% |
| | 11.87 | 1.10 | 2.00 | 28.60 | 26.40 | −2.78% |
| | 16.79 | 1.10 | 1.00 | 28.60 | 26.40 | −2.95% |

Simulation group 5 D = 35

| | | | | | | |
|---|---|---|---|---|---|---|
| First | 4.87 | 1.65 | 36.00 | 35.00 | 31.70 | −1.22% |
| sub- | 4.94 | 1.65 | 35.00 | 35.00 | 31.70 | −1.59% |
| simulation | 5.33 | 1.65 | 30.00 | 35.00 | 31.70 | −1.84% |
| group | 5.84 | 1.65 | 25.00 | 35.00 | 31.70 | −1.68% |
| | 6.53 | 1.65 | 20.00 | 35.00 | 31.70 | −1.21% |
| | 7.54 | 1.65 | 15.00 | 35.00 | 31.70 | −1.18% |
| | 9.24 | 1.65 | 10.00 | 35.00 | 31.70 | −1.49% |
| | 13.06 | 1.65 | 5.00 | 35.00 | 31.70 | −1.66% |
| | 20.66 | 1.65 | 2.00 | 35.00 | 31.70 | −1.57% |
| | 29.21 | 1.65 | 1.00 | 35.00 | 31.70 | −2.01% |
| Second | 3.35 | 1.35 | 36.00 | 35.00 | 32.30 | −1.18% |
| sub- | 3.39 | 1.35 | 35.00 | 35.00 | 32.30 | −1.45% |
| simulation | 3.66 | 1.35 | 30.00 | 35.00 | 32.30 | −1.35% |
| group | 4.01 | 1.35 | 25.00 | 35.00 | 32.30 | −1.23% |
| | 4.49 | 1.35 | 20.00 | 35.00 | 32.30 | −1.32% |
| | 5.18 | 1.35 | 15.00 | 35.00 | 32.30 | −1.52% |
| | 6.35 | 1.35 | 10.00 | 35.00 | 32.30 | −1.70% |
| | 8.98 | 1.35 | 5.00 | 35.00 | 32.30 | −1.21% |
| | 14.19 | 1.35 | 2.00 | 35.00 | 32.30 | −1.53% |
| | 20.07 | 1.35 | 1.00 | 35.00 | 32.30 | −1.08% |
| Third | 2.47 | 1.15 | 36.00 | 35.00 | 32.70 | −1.59% |
| sub- | 2.50 | 1.15 | 35.00 | 35.00 | 32.70 | −1.57% |
| simulation | 2.71 | 1.15 | 30.00 | 35.00 | 32.70 | −1.09% |
| group | 2.96 | 1.15 | 25.00 | 35.00 | 32.70 | −1.66% |
| | 3.31 | 1.15 | 20.00 | 35.00 | 32.70 | −1.49% |
| | 3.83 | 1.15 | 15.00 | 35.00 | 32.70 | −1.29% |
| | 4.69 | 1.15 | 10.00 | 35.00 | 32.70 | −1.05% |
| | 6.63 | 1.15 | 5.00 | 35.00 | 32.70 | −1.34% |
| | 10.48 | 1.15 | 2.00 | 35.00 | 32.70 | −1.32% |
| | 14.82 | 1.15 | 1.00 | 35.00 | 32.70 | −1.33% |

TABLE 3

| | | | | | |
|---|---|---|---|---|---|
| Calculated | | | | | |
| fatigue | | Wall | | Outer | Inner |
| life* | K | thick- | Length | diameter | diameter |
| 10\hat{ }5 | constant | ness t | L | D | d |

Fixed inner diameter d = 6

| | | | | | | |
|---|---|---|---|---|---|---|
| Control | 2.61 | 367914 | 0.50 | 36.00 | 7.00 | 6.00 |
| group 1 | 2.65 | 367914 | 0.50 | 35.00 | 7.00 | 6.00 |
| | 2.86 | 367914 | 0.50 | 30.00 | 7.00 | 6.00 |
| | 3.14 | 367914 | 0.50 | 25.00 | 7.00 | 6.00 |
| | 3.51 | 367914 | 0.50 | 20.00 | 7.00 | 6.00 |
| | 4.05 | 367914 | 0.50 | 15.00 | 7.00 | 6.00 |
| | 4.96 | 367914 | 0.50 | 10.00 | 7.00 | 6.00 |
| | 7.01 | 367914 | 0.50 | 5.00 | 7.00 | 6.00 |
| | 11.09 | 367914 | 0.50 | 2.00 | 7.00 | 6.00 |
| | 15.76 | 369714 | 0.50 | 1.00 | 7.00 | 6.00 |
| Control | 1.80 | 385861 | 0.40 | 36.00 | 6.80 | 6.00 |
| group 2 | 1.82 | 385861 | 0.40 | 35.00 | 6.80 | 6.00 |
| | 1.97 | 385861 | 0.40 | 30.00 | 6.80 | 6.00 |
| | 2.16 | 385861 | 0.40 | 25.00 | 6.80 | 6.00 |
| | 2.41 | 385861 | 0.40 | 20.00 | 6.80 | 6.00 |
| | 2.78 | 385861 | 0.40 | 15.00 | 6.80 | 6.00 |
| | 3.41 | 385861 | 0.40 | 10.00 | 6.80 | 6.00 |
| | 4.82 | 385861 | 0.40 | 5.00 | 6.80 | 6.00 |
| | 7.62 | 385861 | 0.40 | 2.00 | 6.80 | 6.00 |
| | 10.78 | 385861 | 0.40 | 1.00 | 6.80 | 6.00 |

Fixed inner diameter d = 8.52

| | | | | | | |
|---|---|---|---|---|---|---|
| Control | 1.95 | 221994 | 0.50 | 36.00 | 9.52 | 8.52 |
| group 1 | 1.98 | 221994 | 0.50 | 35.00 | 9.52 | 8.52 |
| | 2.13 | 221994 | 0.50 | 30.00 | 9.52 | 8.52 |
| | 2.34 | 221994 | 0.50 | 25.00 | 9.52 | 8.52 |
| | 2.61 | 221994 | 0.50 | 20.00 | 9.52 | 8.52 |
| | 3.02 | 221994 | 0.50 | 15.00 | 9.52 | 8.52 |
| | 3.70 | 221994 | 0.50 | 10.00 | 9.52 | 8.52 |
| | 5.23 | 221994 | 0.50 | 5.00 | 9.52 | 8.52 |
| | 8.26 | 221994 | 0.50 | 2.00 | 9.52 | 8.52 |
| | 11.69 | 221994 | 0.50 | 1.00 | 9.52 | 8.52 |
| Control | 1.64 | 229875 | 0.45 | 36.00 | 9.32 | 8.42 |
| group 2 | 1.33 | 229875 | 0.40 | 35.00 | 9.32 | 8.52 |
| | 1.44 | 229875 | 0.40 | 30.00 | 9.32 | 8.52 |
| | 1.58 | 229875 | 0.40 | 25.00 | 9.32 | 8.52 |
| | 1.76 | 229875 | 0.40 | 20.00 | 9.32 | 8.52 |
| | 2.04 | 229875 | 0.40 | 15.00 | 9.32 | 8.52 |
| | 2.50 | 229875 | 0.40 | 10.00 | 9.32 | 8.52 |
| | 3.53 | 229875 | 0.40 | 5.00 | 9.32 | 8.52 |
| | 5.58 | 229875 | 0.40 | 2.00 | 9.32 | 8.52 |
| | 7.89 | 229875 | 0.40 | 1.00 | 9.32 | 8.52 |

Fixed inner diameter d = 11.5

| | | | | | | |
|---|---|---|---|---|---|---|
| Control | 1.95 | 138259 | 0.60 | 40.00 | 12.70 | 11.50 |
| group 1 | 2.08 | 138259 | 0.60 | 35.00 | 12.70 | 11.50 |
| | 2.25 | 138259 | 0.60 | 30.00 | 12.70 | 11.50 |
| | 2.46 | 138259 | 0.60 | 25.00 | 12.70 | 11.50 |
| | 2.75 | 138259 | 0.60 | 20.00 | 12.70 | 11.50 |
| | 3.18 | 138259 | 0.60 | 15.00 | 12.70 | 11.50 |
| | 3.89 | 138259 | 0.60 | 10.00 | 12.70 | 11.50 |
| | 5.50 | 138259 | 0.60 | 5.00 | 12.70 | 11.50 |
| | 8.70 | 138259 | 0.60 | 2.00 | 12.70 | 11.50 |
| | 12.30 | 138259 | 0.60 | 1.00 | 12.70 | 11.50 |
| Control | 1.41 | 141912 | 0.50 | 40.00 | 12.50 | 11.50 |
| group 2 | 1.50 | 141912 | 0.50 | 35.00 | 12.50 | 11.50 |
| | 1.62 | 141912 | 0.50 | 30.00 | 12.50 | 11.50 |
| | 1.78 | 141912 | 0.50 | 25.00 | 12.50 | 11.50 |
| | 1.99 | 141912 | 0.50 | 20.00 | 12.50 | 11.50 |
| | 2.30 | 141912 | 0.50 | 15.00 | 12.50 | 11.50 |
| | 2.81 | 141912 | 0.50 | 10.00 | 12.50 | 11.50 |
| | 3.98 | 141912 | 0.50 | 5.00 | 12.50 | 11.50 |
| | 6.29 | 141912 | 0.50 | 2.00 | 12.50 | 11.50 |
| | 8.89 | 141912 | 0.50 | 1.00 | 12.50 | 11.50 |

Fixed inner diameter d = 26.4

| | | | | | | |
|---|---|---|---|---|---|---|
| Control | 2.65 | 36428 | 1.10 | 40.00 | 28.60 | 26.40 |
| group 1 | 2.84 | 36428 | 1.10 | 35.00 | 28.60 | 26.40 |
| | 3.07 | 36428 | 1.10 | 30.00 | 28.60 | 26.40 |
| | 3.36 | 36428 | 1.10 | 25.00 | 28.60 | 26.40 |
| | 3.75 | 36428 | 1.10 | 20.00 | 28.60 | 26.40 |
| | 4.34 | 36428 | 1.10 | 15.00 | 28.60 | 26.40 |
| | 5.31 | 36428 | 1.10 | 10.00 | 28.60 | 26.40 |
| | 7.51 | 36428 | 1.10 | 5.00 | 28.60 | 26.40 |
| | 11.87 | 36428 | 1.10 | 2.00 | 28.60 | 26.40 |
| | 16.79 | 36428 | 1.10 | 1.00 | 28.60 | 26.40 |
| Control | 1.84 | 37281 | 0.90 | 40.00 | 28.20 | 26.40 |
| group 2 | 1.97 | 37281 | 0.90 | 35.00 | 28.20 | 26.40 |
| | 2.13 | 37281 | 0.90 | 30.00 | 28.20 | 26.40 |
| | 2.33 | 37281 | 0.90 | 25.00 | 28.20 | 26.40 |
| | 2.61 | 37281 | 0.90 | 20.00 | 28.20 | 26.40 |
| | 3.01 | 37281 | 0.90 | 15.00 | 28.20 | 26.40 |
| | 3.68 | 37281 | 0.90 | 10.00 | 28.20 | 26.40 |
| | 5.21 | 37281 | 0.90 | 5.00 | 28.20 | 26.40 |
| | 8.24 | 37281 | 0.90 | 2.00 | 28.20 | 26.40 |
| | 11.65 | 37281 | 0.90 | 1.00 | 28.20 | 26.40 |

Fixed inner diameter d = 32.7

| | | | | | | |
|---|---|---|---|---|---|---|
| Control | 2.47 | 26142 | 1.15 | 36.00 | 35.00 | 32.70 |
| group 1 | 2.50 | 26142 | 1.15 | 35.00 | 35.00 | 32.70 |
| | 2.71 | 26142 | 1.15 | 30.00 | 35.00 | 32.70 |
| | 2.96 | 26142 | 1.15 | 25.00 | 35.00 | 32.70 |
| | 3.31 | 26142 | 1.15 | 20.00 | 35.00 | 32.70 |
| | 3.83 | 26142 | 1.15 | 15.00 | 35.00 | 32.70 |
| | 4.69 | 26142 | 1.15 | 10.00 | 35.00 | 32.70 |
| | 6.63 | 26142 | 1.15 | 5.00 | 35.00 | 32.70 |
| | 10.48 | 26142 | 1.15 | 2.00 | 35.00 | 32.70 |
| | 14.82 | 26142 | 1.15 | 1.00 | 35.00 | 32.70 |
| Control | 1.57 | 26767 | 0.90 | 36.00 | 34.50 | 32.70 |
| group 2 | 1.59 | 26767 | 0.90 | 35.00 | 34.50 | 32.70 |
| | 1.72 | 26767 | 0.90 | 30.00 | 34.50 | 32.70 |
| | 1.88 | 26767 | 0.90 | 25.00 | 34.50 | 32.70 |
| | 2.11 | 26767 | 0.90 | 20.00 | 34.50 | 32.70 |
| | 2.43 | 26767 | 0.90 | 15.00 | 34.50 | 32.70 |
| | 2.98 | 26767 | 0.90 | 10.00 | 34.50 | 32.70 |
| | 4.21 | 26767 | 0.90 | 5.00 | 34.50 | 32.70 |
| | 6.66 | 26767 | 0.90 | 2.00 | 34.50 | 32.70 |
| | 9.42 | 26767 | 0.90 | 1.00 | 34.50 | 32.70 |

1. A combined pipe fitting, comprising a first pipe fitting, a second pipe fitting, and a third pipe fitting; both the first pipe fitting and the second pipe fitting are stainless steel pipes, and a first end of the second pipe fitting is connected to the first pipe fitting; the third pipe fitting is a copper pipe and comprises a first connecting section, an effective section, and a second connecting section; the first connecting section is sleeved with a second end of the second pipe fitting; a length of the effective section is L, L is an axial extension distance on the third pipe fitting from an end face of the second end of the second pipe fitting to a direction away from the first pipe fitting, a fatigue life N of the combined pipe fitting is inversely proportional to \sqrt{L}, and 1 mm≤L≤35 mm; and the second connecting section is connected to an external pipe fitting.

2. The combined pipe fitting according to claim 1, wherein the length L and the fatigue life N of the combined pipe fitting satisfy the following formula:
$$N = \frac{k * t * ( {D}^{4} - {d}^{4} )}{\sqrt{LD} * {D}^{2}}$$
where D denotes a maximum outer diameter within the length L of the effective section, d denotes an inner diameter corresponding to D within the length L of the effective section, t denotes a minimum wall thickness within the length L of the effective section, and k denotes a fatigue life coefficient of the combined pipe fitting and decreases monotonically with D as a power function.

3. The combined pipe fitting according to claim 2, wherein the fatigue life coefficient k of the combined pipe fitting has the following power function fitting relationship with D:
$$k = A * \text{?} * \text{?} ,$$
$$\text{?} \text{indicates text missing or illegible when filed}$$
where 7≤A≤10, α is a negative value, and −2≤α≤−1.

4. The combined pipe fitting according to claim 2, wherein when a pressure in the combined pipe fitting fluctuates, a fluctuation differential pressure ΔP is less than or equal to 4 MPa and a fluctuation frequency is 0.2 Hz≤f≤0.3 Hz; and the fatigue life coefficient k of the combined pipe fitting and D satisfy the following power function fitting relationship:
$$k = 9 E + 06 \text{?} , where α = - 1.5 \pm 0.3 .$$
$$\text{?} \text{indicates text missing or illegible when filed}$$

5. The combined pipe fitting according to claim 1, wherein the effective section is a straight pipe section in which both inner and outer diameters remain substantially unchanged and a central axis is approximately straight.

6. The combined pipe fitting according to claim 1, wherein the first connecting section of the third pipe fitting is necked to be sleeved with the second end of the second pipe fitting, and a wall thickness of the first connecting section is greater than or equal to a wall thickness of the effective section.

7. The combined pipe fitting according to claim 1, wherein the second connecting section of the third pipe fitting is sleeved with the external pipe fitting or connected to the external pipe fitting in a sleeving manner, and a sleeving length H satisfies H=βD, where 0.5≤β≤1.5, D denotes a maximum outer diameter within the length L of the effective section, and the sleeving length H refers to a distance from a joint position of the second connecting section and the external pipe fitting to an end face of the second connecting section.

8. The combined pipe fitting according to claim 1, wherein the second connecting section of the third pipe fitting is flared to be connected to the external pipe fitting in a sleeving manner, and a wall thickness of the second connecting section is less than or equal to a wall thickness of the effective section.

9. The combined pipe fitting according to claim 1, wherein a maximum outer diameter of the effective section is 4.2 mm≤D≤35 mm; and a wall thickness of the effective section is 0.3 mm≤t≤1.65 mm.

10. The combined pipe fitting according to claim 1, wherein the first pipe fitting, the second pipe fitting and the third pipe fitting are welded in one piece by furnace brazing.

11. The combined pipe fitting according to claim 1, wherein the first end of the second pipe fitting is connected to an end of the first pipe fitting; alternatively, a connecting hole is provided in a side wall of the first pipe fitting, and the first end of the second pipe fitting is connected to the connecting hole in the first pipe fitting.

12. The combined pipe fitting according to claim 1, wherein the combined pipe fitting comprises a plurality of second pipe fittings and a plurality of third pipe fittings, a plurality of connecting holes are provided in a pipe wall of the first pipe fitting, the first ends of the second pipe fittings are connected to the corresponding connecting holes, and the second ends of the second pipe fittings are connected to the corresponding third pipe fittings.

13. An air conditioning system pipeline, comprising:
the combined pipe fitting according to claim 1; and
an external pipe fitting connected to a second connecting section of a third pipe fitting.
